(19) United States
(12) Patent Application Publication
(10) Pub. No.: US 2015/0279517 A1
(43) Pub. Date: Oct. 1, 2015

(54) PATCH CABLE, SYSTEM AND METHOD FOR CLEAR IDENTIFICATION OF COMPUTER AND COMMUNICATION NETWORK CABLING

(71) Applicant: Blake Lenus Boudreaux, Lulling, LA (US)

(72) Inventor: Blake Lenus Boudreaux, Lulling, LA (US)

(21) Appl. No.: 14/225,944

(22) Filed: Mar. 26, 2014

(51) Int. Cl. H01B 7/36; G02B 6/44; H01R 43/00; H01R 13/46

(52) U.S. Cl. CPC H01B 7/365; H01R 13/465; G02B 6/4439; H01R 43/00

(57) ABSTRACT

The patch cable, patch cable system and method of providing clear identification of cabling in computer and communication networks employing a multitude of cables, provide a common standard for identification of the multitude of patch cables in groups of sets and subsets of the patch cables utilizing a combination of cable color, a primary accent color and a secondary accent color arranged on each patch cable to uniquely identify the patch cable, and the patch cable subset and group. A numerical or alphabetical additional coding is provided on the patch cables matching the color coding sequencing to provide secondary identification of the patch cable, subset and group.

### TECHNICAL FIELD

The invention relates to an improved method of providing clear identification of cabling in computer and communication networks employing a multitude of cables, and to an improved patch cable and patch cable system therefor.

### BACKGROUND AND SUMMARY

The prevalent use of computer and communication equipment and increasing changes in technology have increased the need for system interconnections. Computer and communication network systems are made up of a multitude of devices. It is common to have networks with hundreds of cable connections. The multitude of cables and density of the systems make cable identification a difficult but necessary task. It is common to see technicians slowly following a cable through dense bundles of cables trying to keep contact with a specific cable due to poor identification. It is not unusual for technicians to lose track of a cable while tracing or get crossed up and end up tracing the wrong cable. Poor identification increases down time and the risk of system failure due to technician error.

Conventional identification methods include a multitude of labeling options. The use of the current twelve standard cable colors is used in conjunction with labeling in some cases. Some of the problems with labels are: it is hard to locate specific cables and labels within a large cluster; they are difficult to read due to the small print which is dictated by the cable size; they do not stay attached over time and tend to fall off leaving the cable with no identification. Another drawback to the conventional identification methods is they are identified to match the network infrastructure scheme. Patch cables were created for and are used on computer and communication network systems for their flexibility and portability. Conventional identification methods are semi-permanent and are not conducive to being flexible and portable. Using identification schemes associated with the network infrastructure removes any flexibility and portability provided by the patch cable. Time must be taken to remove the current identification and update it any time a cable is moved around on the network. There is a need for an improved patch cable, patch cable system and method of providing clear identification of cabling in computer and communication networks which avoid these drawbacks and disadvantages. The present invention addresses this need.

The improved patch cable, patch cable system and method of using the same of the invention as disclosed in example embodiments described herein utilize a vivid color coding and alpha numerical system formed of sets and subsets of coding. The system provides unique sets of cables making the use of other identification methods unnecessary. The invention offers multiple advantages over the prior art. The coding system provides a common standard for identification of patch cables. The unique identifications are a permanent part of the cable and can't fall off or be removed. It provides enough color combinations to allow several sets on the same rack making it possible to identify multiple networks. Unique properties of the system make it simple to move cables from port to port without the need to replace other identification. Not relying on other identification methods saves staff time and supplies normally required in such methods.

The invention improves the identification of computer and communication network patch cables of copper, fiber optic cable or other material used for signal routing. The cables are identified with accent colors which can be printed, laser marked, extruded in the sheathing, added by colored shrink tubing rings at regular intervals, or other method of cable marking. The cable is identified additionally in the example embodiments with a coding number at each end, which may also be placed at regular intervals along the cable. The coding numbers match the color coding sequencing. The cable has connectors attached at both ends each protected and identified with a colored strain relief boot, connector or other method of cable marking. The combinations of colors of the cable, accent color, and colored ends provide a large set of uniquely identified cables.

More particularly, a patch cable according to the invention comprises a cable for connecting at least one of electronic devices and optical devices to one another for signal routing, the cable having an outer sheathing and a connector at each of first and second ends of the cable, and a color coding permanently provided on the patch cable. The color coding conforms to a common standard for identification of a patch cable from among a plurality of groups of sets and subsets of patch cables wherein the color coding comprises a combination of a cable color, a primary accent color and a secondary accent color arranged on each patch cable to uniquely identify the patch cable and the patch cable subset and group. In accordance with example embodiments, the primary accent color identifies the group and is the color of at least one of a cable end, a connector, a strain relief boot of a connector, and a stripe on the cable. The cable color is one of a plurality of standard cable colors of the outer sheathing on the cable. The secondary accent color is the color of at least one stripe on the sheathing of the cable. The stripe is at least one of a spiral, a ring, and a linear stripe along the length of the cable. The secondary accent color identifies the subset of the group of the patch cable. In accordance with the example embodiments, the secondary accent color identifies the subset as the color of the secondary color where the cable color is one of a plurality of fixed cable colors of the subset, and identifies the subset as the color of the cable where the secondary accent color is one of the plurality of fixed cable colors of the subset.

The improved patch cable according to the example embodiments further comprises an additional coding provided on the patch cable in the form of at least one of a numerical coding and an alphabetical coding, the additional coding providing secondary identification of the patch cable and the patch cable subset and group. The additional coding has indicia matching the color coding sequencing of the patch cable.

A patch cable system according to the invention provides clear identification of cabling in computer and communication networks employing a multitude of cables. The system comprises a multitude of patch cables divided into groups of sets and subsets of patch cables, each patch cable being provided with a permanent color coding thereon conforming the multitude of patch cables to a common standard for identification of the patch cables, the color coding comprising a combination of a cable color, a primary accent color and a secondary accent color arranged on each patch cable to uniquely identify the group of the patch cable, the subset of the patch cable within the group, and the patch cable within the subset of the group. An additional coding on each patch cable provides a secondary patch identification of the group of the patch cable, the subset of the patch cable within the group, and the patch cable within the subset of the group as noted above.

Thus, the improved method of providing clear identification of cabling in computer and communication networks employing a multitude of cables in accordance with the invention comprises providing a multitude of patch cables including a plurality of groups of sets and subsets of patch cables wherein each patch cable has a permanent color coding with a unique identification of the patch cable, and the subset and the group of a patch cable as part of a common standard for identification of patch cables across the multitude of patch cables, and making network connections using patch cables from the multitude of patch cables.

These and other objects, features and advantages of the present invention will become more apparent from the following detailed description of example embodiments taken with the accompanying drawings.

### BRIEF DESCRIPTION OF DRAWINGS

FIG. 1A is a side view of one end of a patch cable according to a first embodiment of the invention showing a connector with a strain relief boot of the primary accent color at one end of the cable and a spiral stripe of the secondary accent color on the colored cable.

FIG. 1B is an end view of the connector from the left side as shown in FIG. 1A.

FIG. 1C is a top view of the patch cable of FIG. 1A, showing the connector and strain relief boot of the connector.

FIG. 1D is a side view of the second end of the patch cable of FIGS. 1A-1C.

FIG. 2 is a top view similar to FIG. 1C showing a variation of the patch cable with an end of the cable being colored the primary accent color of the color coding instead of or in addition to the connector strain relief boot as in FIGS. 1A-1D.

FIG. 3A is side view of the left end of another embodiment of the patch cable wherein the cable is provided with stripes in the form of spaced rings having the secondary accent color.

FIG. 3B is a side view of the right end of the patch cable of FIG. 3A.

FIG. 3C is a side view of the left end of a further variation of the patch cable in which the secondary accent color stripes are linear and extend along the length of the cable.

FIG. 3D is a side view of the right end of the patch cable of FIG. 3C.

FIG. 4 is a chart showing an example of possible sequencing of color coding of group and subset colors for the cables matched with numerals of the additional numerical code provided on the cables for secondary identification of the groups, subsets and cables.

FIG. 5 is an example of a numerical coding with three numbers of the code shown with labels identifying the number associated with the group, subset and cable.

FIG. 6 is a chart showing an example of the cable coding system of the invention with a cable color coding and a matching numerical coding in sequence for each of 70 patch cables of a group I and showing a portion of the 70 patch cables of a group 2.

FIG. 7 is an illustration of the color coding using multiple colored rings to identify the cable with each cluster of three rings including a single, center ring of the secondary accent color between two rings of the primary accent color, all rings overlaid on the cable color.

FIG. 8 is another example of the color coding using multiple colored rings to identify the cable wherein the color of the center, wider ring in each cluster of three rings on the cable is the primary accent color and the other two rings of each cluster are the secondary accent color, all rings overlaid on the cable color.

FIG. 9 is a further embodiment of the color coding using multiple colored stripes to identify the cable, the stripes being linear along the cable length with the two darker stripes of the primary accent color on respective sides of the center stripe of secondary accent color, the stripes being overlaid on the cable color.

### DETAILED DESCRIPTION

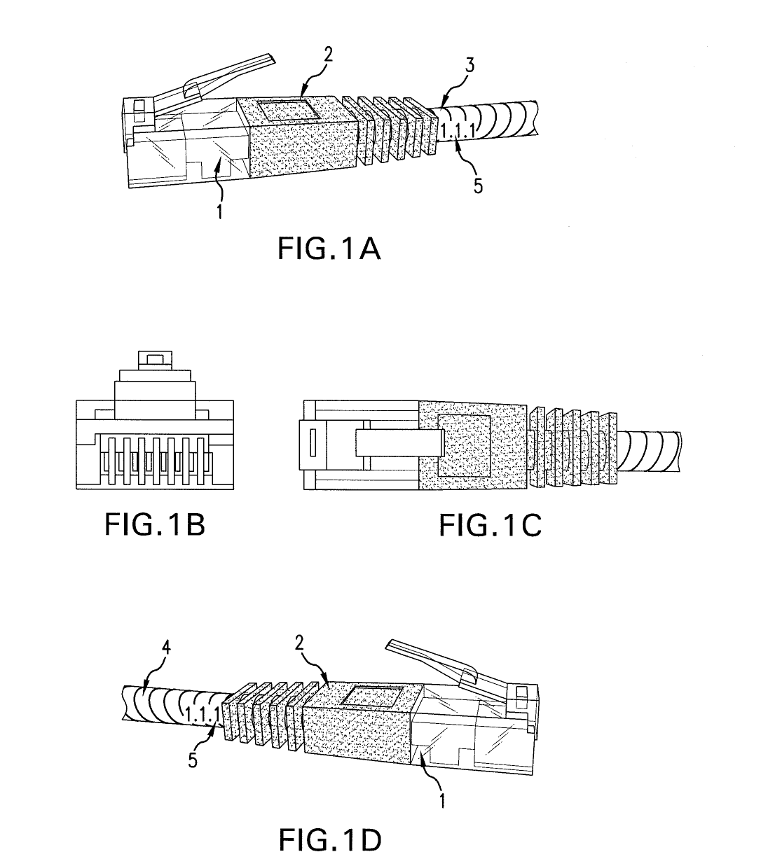

Referring now to the drawings, FIGS. 1A to 1D illustrate a copper, color coded patch cable, particularly two ends of the cable which are connected by any length of cable required for its use. Each end of the cable has a cable connector 1. Each connector includes a strain relief boot 2. The color of the boot, referred to as the primary accent color, identifies the group of the cable sets among a plurality of groups. In some cases strain relief boots may not be used in which case colored marking as the primary accent color may be added to the outer sheathing of the cable at the end of the cable. The outer sheathing 3 is identified in FIGS. 1A and 1D.

There are currently twelve standard or fixed cable colors available. These include brown and slate and the ten colors identified in FIG. 4, but the invention is not limited to these as custom colors could be employed as the plurality of different colors for the cables in the groups of sets and subsets of patch cables in the patch cable system. A colored striping 4, FIG. 1D, spirals around the entire length of the cable providing a secondary accent color. Using colored striping greatly increases the number of cables available with the use of only the currently available twelve standard cable colors. A numerical coding 5, FIGS. 1A and 1D, is associated with the coloring. The numbers of the numerical coding are separated by decimals. The first number position displays the group number, the second number position displays the number for the subset of the group, and the third number position displays the cable number within the subset.

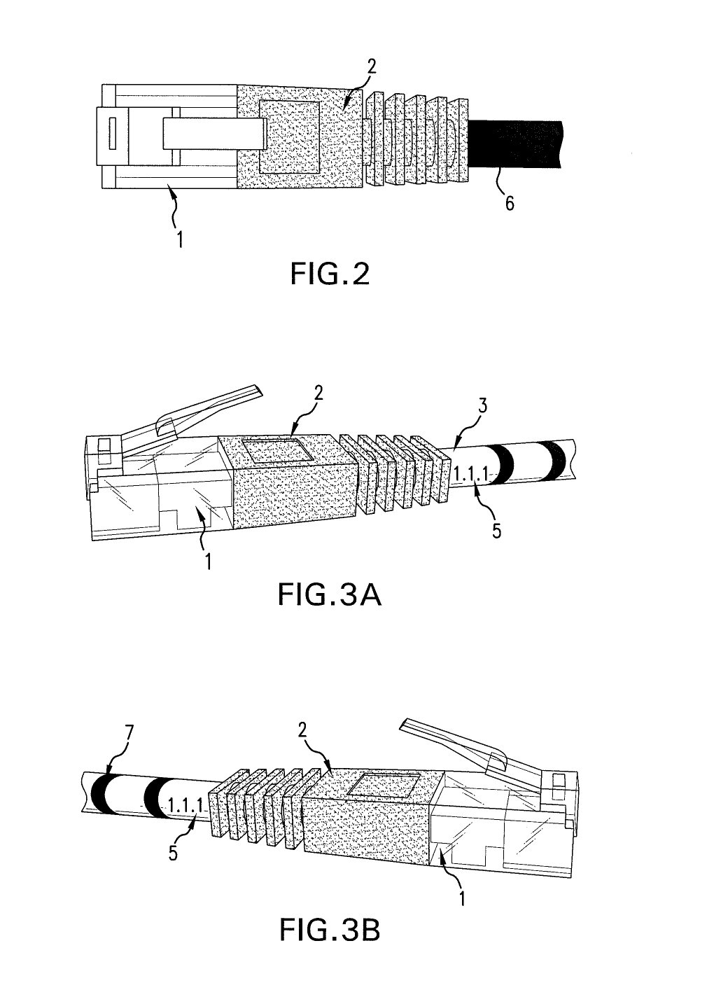

FIG. 2 is an illustration of a copper color coded patch cable. In this form of the invention, the end 6 of the cable adjacent the strain relief boot 2 is colored the primary accent color of the color coding instead of or in addition to the connector strain relief boot as in FIGS. 1A-1D.

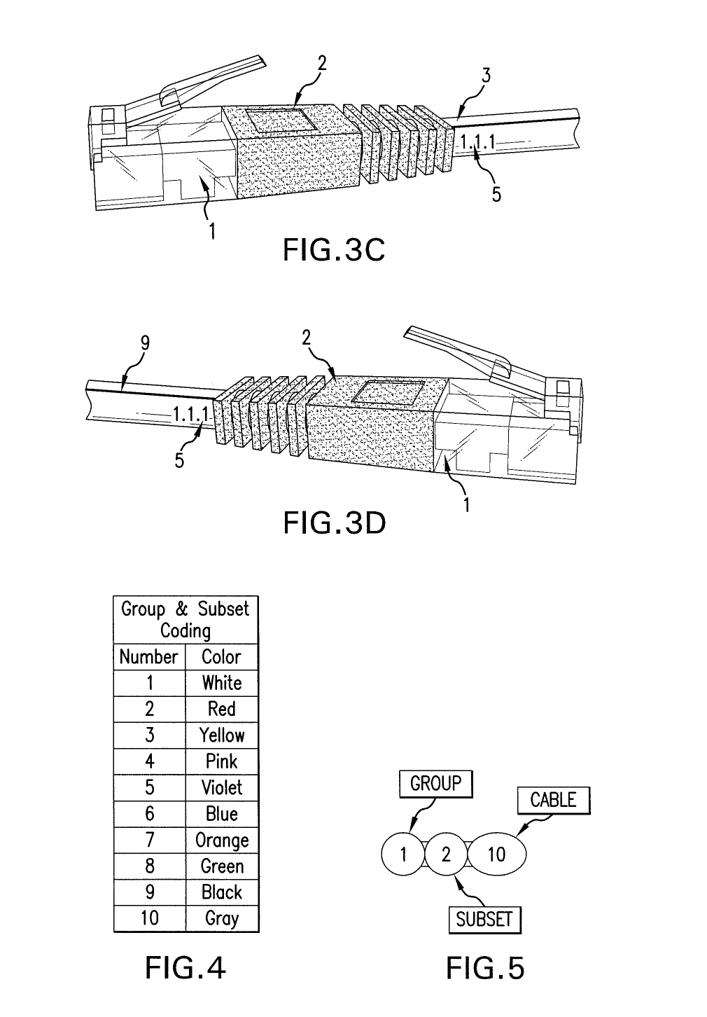

The left and right ends of the embodiment of the patch cable illustrated in FIGS. 3A and 3B depict the cable provided with stripes in the form of spaced rings 7 of the secondary accent color marked at the cable ends or optionally along the entire length of the cable. The numerical coding 5 is additionally provided on at least the cable ends and, optionally, spaced at regular intervals along the entire length of the cable.

The patch cable with its two ends shown in FIGS. 3C and 3D is a form of the invention wherein the colored stripe of the secondary accent color on the cable, 9, extends straight down the entire length of the cable. Using colored striping greatly increases the number of cables available. The patch cable again includes numerical coding 5 at least at the ends of the cable adjacent the connector strain relief boot 2. FIG. 4 provides an explanatory example of the numerical coding. The example is only for explanation purposes and is not claiming to code in these exact number and color combinations. FIG. 5 illustrates an explanatory example of the numerical coding as referred to above.

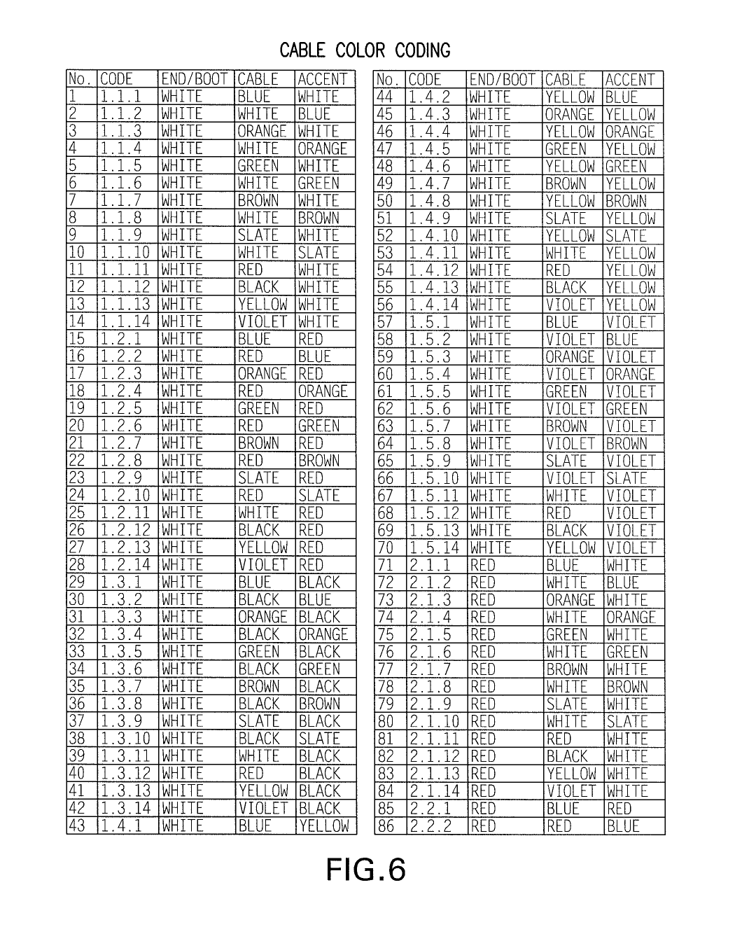

FIG. 6 illustrates an explanatory example of the coding system as it relates to multiple patch cables. The example is only for explanation purposes and is not claiming to code in these exact number and color combinations. Each group in the example cable color coding contains 70 patch cables arranged in 5 subsets of 14 patch cables each. Extending the coding fully to 10 groups affords 700 uniquely identifiable patch codes each having a color coding conforming to a common standard for identification of the patch cables from among the plurality of groups of sets and subsets wherein the color coding comprises a combination of a cable color, a primary accent color and a secondary accent color arranged on each patch cable to uniquely identify the patch cable and the patch cable subset and group. The numerical coding 5 on the patch cable permits a secondary identification matching that provides by the color coding.

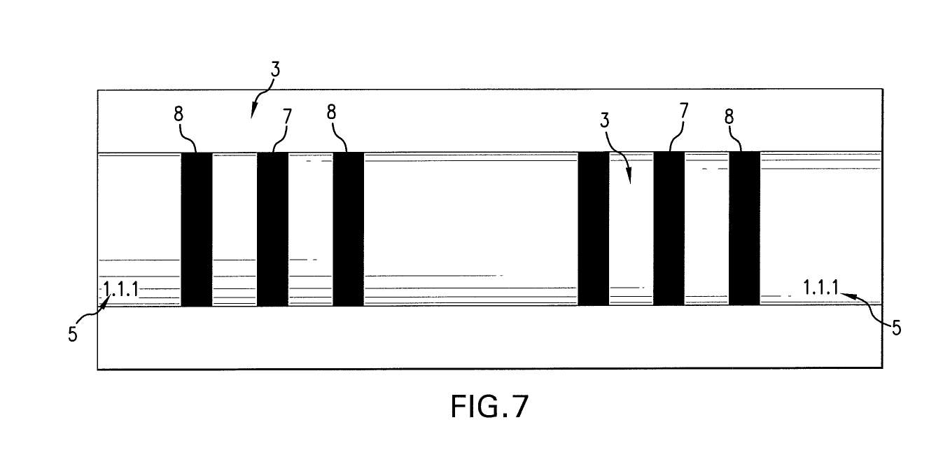

The form of the patch cable color coding in FIG. 7 improves the identification of the primary accent color in that stripes in the form of rings are provided about the cable in both the primary accent color and the secondary accent color. The two are distinguished in that the primary accent color is striped with two stripes 8 and the secondary accent color is in a single stripe 7. Alternatively, the primary accent color may be striped with a wider stripe then the secondary accent color to differentiate the two.

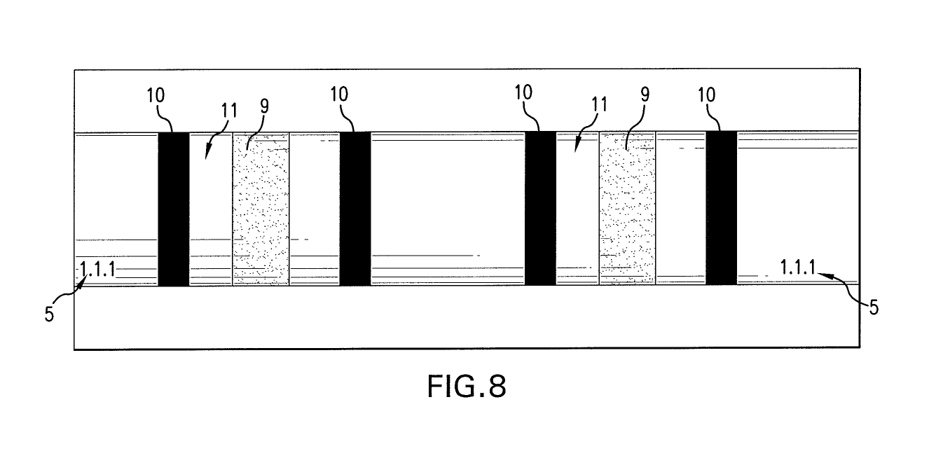

The embodiment of the color coded patch cable shown in FIG. 8 exploits multiple colored rings to identify the cable wherein the color of the center, wider ring in each cluster of three rings on the cable is the primary accent color and the other two rings 10 of each cluster are the secondary accent color, all rings overlaid on the cable color 11. Alternatively, the second ring 10 can be omitted with the secondary color being differentiated by a wider ring.

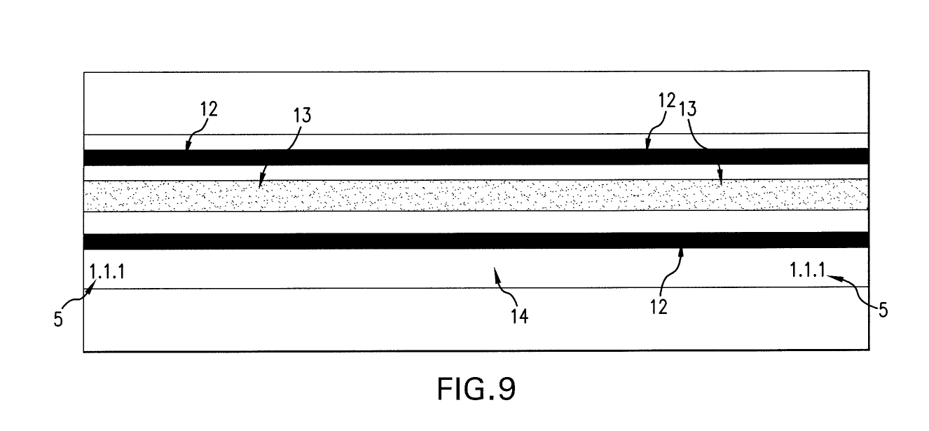

The patch cable and the embodiment of FIG. 9 utilizes a color coding having multiple colored stripes to identify the cable, the stripes being linear along the cable length with the two stripes of the primary color 12 on respective sides of the center stripe of secondary accent color 13, the stripes being overlaid on the cable color 14.

The patch cables in the patch cable system of the present invention are identified either as accent cables or standard color cables, e.g. fixed cables. Fixed cables are a part of every group and subset. Each fixed cable is identified with the primary accent color, the group color matching the accent cable for the subset. The subset accent cable is identified by marking it with an accent stripe matching each of the fixed cables. For example, where a white cable is an accent cable and a blue cable a fixed cable, the white cable would be identified with a blue stripe and the blue cable would be identified with a white stripe both being part of the white subset. That is, the secondary accent color of a patch cable identifies the subset as the color of the secondary accent color where the cable color is one of a plurality of fixed cable colors of the subset, and identifies the subset as the color of the cable where the secondary accent color is one of the plurality of fixed cable colors of the subset. With reference to FIG. 6, group wherein the primary accent color is white and subset 1 wherein the secondary accent color is white, it is seen that for the cable bearing the numerical code 1.1.1, the cable color is one of a plurality of fixed cable colors of the subset (blue, orange, green, brown, slate, red, black, yellow and violet). Thus, the secondary accent color is identified as the subset color. In contrast, for cable 1.1.2, where the cable is white, not one of the fixed cable colors of the subset, the color of the subset is identified as the color of the cable, e.g., white.

Preferred embodiments of this invention are described herein, including the best mode known to the inventor for carrying out the invention. It should be understood that the illustrated embodiments are exemplary only, and should not be taken as limiting the scope of the invention.

1. A patch cable comprising:
a cable for connecting at least one of electronic devices and optical devices to one another for signal routing, the cable having an outer sheathing and a connector at each of first and second ends of the cable, and
a color coding permanently provided on the patch cable, the color coding conforming to a common standard for identification of a patch cable from among a plurality of groups of sets and subsets of patch cables wherein the color coding comprises a combination of a cable color, a primary accent color and a secondary accent color arranged on each patch cable to uniquely identify the patch cable and the patch cable subset and group.

2. The patch cable according to claim 1, wherein the primary accent color identifies the group.

3. The patch cable according to claim 1, wherein the primary accent color is the color of at least one of a cable end, a connector, a strain relief boot of a connector, and a stripe on the cable.

4. The patch cable according to claim 1, wherein the cable color is one of a plurality of cable colors of the outer sheathing of the cables used in the plurality of groups of sets and subsets of patch cables.

5. The patch cable according to claim 1, wherein the secondary accent color is the color of at least one stripe on the sheathing of the cable.

6. The patch cable according to claim 5, wherein the stripe is at least one of a spiral, a ring, and a linear stripe along the length of the cable.

7. The patch cable according to claim 1, wherein the combination of a cable color, a primary accent color and a secondary accent color is provided at each end of the cable.

8. The patch cable according to claim 7, wherein the combination is provided at regular intervals over the entire length of the cable.

9. The patch cable according to claim 1, wherein the secondary accent color identifies the subset of the group of the patch cable.

10. The patch cable according to claim 9, wherein the secondary accent color identifies the subset as the color of the secondary accent color where the cable color is one of a plurality of fixed cable colors of the subset, and identifies the subset as the color of the cable where the secondary accent color is one of the plurality of fixed cable colors of the subset.

11. The patch cable according to claim 1, further comprising an additional coding provided on the patch cable in the form of at least one of a numerical coding and an alphabetical coding, the additional coding providing secondary identification of the patch cable and the patch cable subset and group, the additional coding having indicia matching the color coding sequencing of the patch cable.

12. The patch cable according to claim 11, wherein the additional coding includes a first indicum identifying the group of the patch cable, a second indicum identifying the subset of the patch cable and a third indicum indentifying the patch cable.

13. The patch cable according to claim 1, wherein the cable is one of fiber optic strains bundled within the outer sheathing, multiple individually insulated electrical conductors within the outer sheathing, a coaxial cable, a twisted pair cable, and a single conductor wire.

14. A patch cable system providing clear identification of cabling in computer and communication networks employing a multitude of cables, the patch cable system comprising:
a multitude of patch cables divided into groups of sets and subsets of patch cables, each patch cable being provided with a permanent color coding thereon conforming the multitude of patch cables to a common standard for identification of the patch cables, the color coding comprising a combination of a cable color, a primary accent color and a secondary accent color arranged on each patch cable to uniquely identify the group of the patch cable, the subset of the patch cable within the group, and the patch cable within the subset of the group.

15. The patch cable system according to claim 14, further comprising an additional coding on each patch cable providing a secondary identification of the group of the patch cable, the subset of the patch cable within the group, and the patch cable within the subset of the group.

16. The patch cable system according to claim 14, wherein the primary accent color identifies the group of the cable and the secondary accent color identifies the subset of the patch cable.

17. A method of providing clear identification of cabling in computer and communication networks employing a multitude of cables, the method comprising:
providing a multitude of patch cables including a plurality of groups of sets and subsets of patch cables wherein each patch cable has a permanent color coding with a unique identification of the patch cable, and the subset and the group of the patch cable as part of a common standard for identification of patch cables across the multitude of patch cables,
making network connections using patch cables from the multitude of patch cables.

18. The method of claim 17, including providing an additional coding on the multitude of patch cables in the form of at least one of a numerical coding and an alphabetical coding, the additional coding having indicia matching the color coding sequencing and providing secondary identification of the patch cable and the patch cable subset and group.

19. The method of claim 17, including providing as the color coding a combination of a cable color, a primary accent color and a secondary accent color arranged on each patch cable to uniquely identify the patch cable and patch cable subset and group.
